(19) United States
(12) Patent Application Publication
(10) Pub. No.: US 2020/0096893 A1
(43) Pub. Date: Mar. 26, 2020

(54) IMAGE FORMING APPARATUS

(71) Applicant: CANON KABUSHIKI KAISHA, Tokyo (JP)

(72) Inventors: Michihiro Yoshida, Nagareyama-shi (JP); Tadashi Fukuda, Tokyo (JP); Masahiro Makino, Tsukubamirai-shi (JP); Mikihiro Akasaki, Matsudo-shi (JP); Keisuke Kinai, Tokyo (JP)

(21) Appl. No.: 16/560,042

(22) Filed: Sep. 4, 2019

(30) Foreign Application Priority Data
Sep. 26, 2018 (JP) 2018-179898

(51) Int. Cl. G03G 15/02; G03G 15/08; G03G 5/05; G03G 5/07

(52) U.S. Cl. CPC G03G 15/0233; G03G 15/0808; G03G 2215/2051; G03G 5/07; G03G 5/0564

(57) ABSTRACT

An image forming apparatus includes a photosensitive member and a charge roller. The photosensitive member comprises a base body, and a photosensitive layer which is a monolayer formed on the base body and comprises a charge generating agent, a charge transport agent and a binder resin. The charge roller configured to contact the photosensitive member and charge the photosensitive member by application of only a DC voltage. The charge roller comprises a conductive rubber layer, and a ten-point average roughness of a surface of the charge roller is 0.9 μm or more and 8.5 μm or less.

### BACKGROUND OF THE INVENTION

### Field of the Invention

The present invention relates to an image forming apparatus utilizing an electrophotographic technique, such as a printer, a copying machine, a facsimile or a multifunction machine.

### Description of the Related Art

In an image forming apparatus adopting an electrophotographic system, electrostatic latent image is formed by an exposing unit on a photosensitive drum charged to target charging potential by a charging device, and the electrostatic latent image is developed into a toner image by a developing apparatus. As a photosensitive drum, an organic photosensitive member having a monolayer of photosensitive layer in which a charge generating agent, a charge transport agent and a binder resin are contained in a single layer is known (Japanese Patent Application Publication No. 2012-014141). A charge roller that contacts and charges the photosensitive drum is used as the charging device. A DC charge system is adopted where only DC voltage is applied to the charge roller, and the photosensitive drum is charged by generating discharge in a gap formed between the photosensitive drum and the charge roller.

However, in a case where the photosensitive drum is an organic photosensitive member having the above-described monolayer of photosensitive layer, heretofore, unevenness of density of image occurred due to surface profile, i.e., roughness, of the charge roller.

In consideration of the problems described above, the present invention provides an image forming apparatus that adopts a configuration in which the photosensitive member having a monolayer of photosensitive layer is charged only by applying DC voltage to the charge roller, wherein unevenness of density of image caused by the surface profile of the charge roller rarely occurs.

### SUMMARY OF THE INVENTION

According to one aspect of the present invention, an image forming apparatus includes a photosensitive member comprising a base body, and a photosensitive layer which is a monolayer formed on the base body and comprises a charge generating agent, a charge transport agent and a binder resin, and a charge roller configured to contact the photosensitive member and charge the photosensitive member by application of only a DC voltage. The charge roller comprises a conductive rubber layer, and a ten-point average roughness of a surface of the charge roller is 0.9 μm or more and 8.5 μm or less.

Further features of the present invention will become apparent from the following description of exemplary embodiments with reference to the attached drawings.

### BRIEF DESCRIPTION OF THE DRAWINGS

FIG. 1 is a schematic drawing illustrating a configuration of an image forming apparatus according to a present embodiment.

FIG. 2 is a cross-sectional view illustrating a developing apparatus.

FIG. 3 is a cross-sectional view illustrating a photosensitive drum.

FIG. 4A is a graph illustrating a relationship between surface profile of charge roller and charging potential of a case where a surface roughness (Rz) is 12 μm.

FIG. 4B is a graph illustrating a relationship between surface profile of the charge roller and charging potential of a case where the surface roughness (Rz) is 5 μm.

FIG. 5A is a graph illustrating a relationship between pre-exposure and charging potential of a case where the surface roughness (Rz) is 5 μm.

FIG. 5B is a graph illustrating a relationship between pre-exposure and charging potential of a case where the surface roughness (Rz) is 12 μm.

FIG. 6A is a graph illustrating a relationship between pre-charging potential and charging potential of a case where the surface roughness (Rz) is 5 μm.

FIG. 6B is a graph illustrating a relationship between pre-charging potential and charging potential of a case where the surface roughness (Rz) is 12 μm.

### DESCRIPTION OF THE EMBODIMENTS

### Image Forming Apparatus

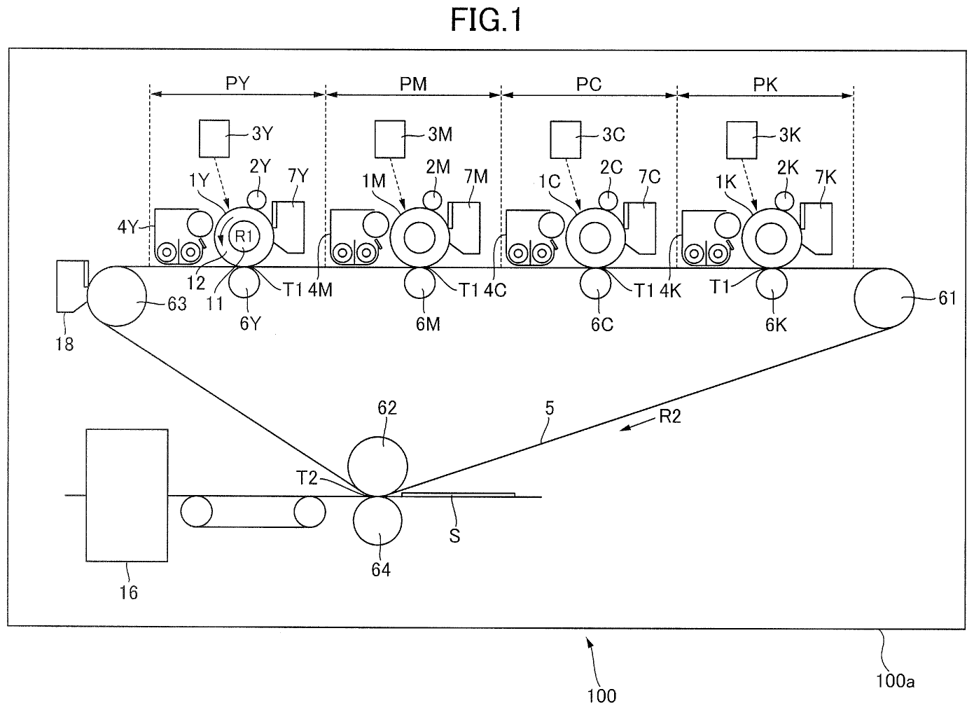

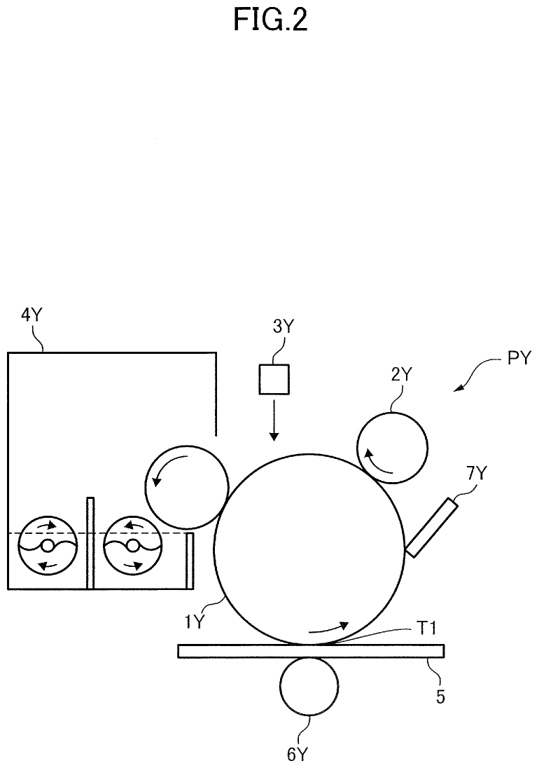

A configuration of an image forming apparatus according to the present embodiment will be described with reference to FIGS. 1 and 2. An image forming apparatus 100 according to FIG. 1 is a tandem-type full color printer in which image forming units PY, PM, PC and PK corresponding to yellow, magenta, cyan and black are arranged along an intermediate transfer belt 5.

In an image forming unit PY, a yellow toner image is formed on a photosensitive drum 1Y and transferred to the intermediate transfer belt 5. In the image forming unit PM, a magenta toner image is formed on a photosensitive drum 1M and transferred to the intermediate transfer belt 5. In image forming units PC and PK, a cyan toner image and a black toner image are respectively formed on photosensitive drums 1C and 1K, and the images are then transferred to the intermediate transfer belt 5. The four color toner images transferred to the intermediate transfer belt 5 are conveyed to a secondary transfer portion T2 along with the movement of the intermediate transfer belt 5, and the images are secondarily transferred to a recording material S, which are sheet materials such as paper and OHP sheets. The recording material S is taken out one sheet at a time from a sheet feed cassette not shown and conveyed to the secondary transfer portion T2.

The image forming units PY, PM, PC and PK have similar configurations, except for the difference in the toner colors, which are respectively yellow, magenta, cyan and black for each of the developing apparatuses 4Y, 4M, 4C and 4K. In the following description, the image forming unit PY using yellow toner is described as a representative example, and the description of other image forming units PM, PC and PK are omitted.

As illustrated in FIG. 2, in the image forming unit PY, a charge roller 2Y, an exposing unit 3Y, a developing apparatus 4Y, a transfer roller 6Y and a cleaning blade 7Y are arranged to surround a photosensitive drum 1Y serving as an image bearing member. The photosensitive drum 1Y has a photosensitive layer formed on a conductive base body, which is rotated in an arrow R1 direction of FIG. 1 at a predetermined process speed. In a state where DC charge voltage is applied to the charge roller 2Y, the charge roller 2Y charges the photosensitive drum 1Y to a dark potential having a uniform positive polarity. According to the present embodiment, only DC voltage of “+1000 to +1200 V” is applied from a power supply not shown to the charge roller 2Y so that a surface potential of the photosensitive drum 1Y becomes “+400 V”. The photosensitive drum 1Y and the charge roller 2Y described above will be described in detail later.

The exposing unit 3Y generates a laser beam from a laser emitting element based on an on-off modulation of a scanning line image data obtained by developing color separation images of respective colors, and the laser beam is scanned by a rotation mirror to draw an electrostatic latent image on the surface of the charged photosensitive drum 1Y. The developing apparatus 4Y supplies toner to the photosensitive drum 1Y and develops the electrostatic latent image into a toner image. In the present embodiment, a toner having a mean particle diameter of approximately 4 to 6 μm is used.

The transfer roller 6Y is arranged to oppose to the photosensitive drum 1Y interposing the intermediate transfer belt 5, and a primary transfer portion T1 of toner image is formed between the photosensitive drum 1Y and the intermediate transfer belt 5. At the primary transfer portion T1, primary transfer voltage is applied to the transfer roller 6Y from a power supply not shown, by which a toner image is primarily transferred from the photosensitive drum 1Y to the intermediate transfer belt 5. The cleaning blade 7Y removes the toner remaining on the photosensitive drum 1Y after primary transfer.

Returning to FIG. 1, the intermediate transfer belt 5 is wound around and supported by rollers include a tension roller 61, a secondary transfer inner roller 62 and a drive roller 63, and driven by the drive roller 63 to rotate in an arrow R2 direction of FIG. 1. In the present embodiment, a belt formed of polyether ether ketone and having a volume resistivity ρv of 10¹⁰ (Ω·cm) and a surface resistivity ρs of 10⁸ (Ω) was used. The intermediate transfer belt should preferably have a volume resistivity ρv of 10⁸ (Ω·cm) to 10¹² (Ω·cm) and a surface resistivity ρs of 10⁸ (Ω) to 10¹³ (Ω), and generally, materials such as polyether ether ketone or polyimide are used.

The secondary transfer portion T2 is a transfer nip portion of toner image to the recording material S that is formed by abutting the secondary transfer inner roller 62 against the intermediate transfer belt 5 supported by a secondary transfer outer roller 64. In the secondary transfer portion T2, toner image is secondarily transferred from the intermediate transfer belt 5 to the recording material S by having secondary transfer voltage applied to the secondary transfer inner roller 62. Toner remaining on the intermediate transfer belt 5 after secondary transfer is removed by a belt cleaning device 18.

The recording material S to which the toner image has been secondarily transferred at the secondary transfer portion T2 is conveyed to a fixing unit 16. Although not illustrated, the fixing unit 16 applies pressure by an opposing roller or a belt and heat by a heat source such as a heater to thereby fix the toner image on the recording material S. The recording material S to which toner image has been fixed by the fixing unit 16 is discharged to the exterior of the apparatus.

### Photosensitive Drum

Next, the photosensitive drum 1Y will be explained. In the present embodiment, the photosensitive drum 1Y is a cylindrical organic photosensitive member, and as illustrated in FIG. 1, the photosensitive drum 1Y includes a conductive base body 11 and a photosensitive layer 12. The photosensitive layer 12 is a monolayer of photosensitive member having a charge generating agent, a charge transport agent and a binder resin contained in one layer. The photosensitive drum 1Y can further include a layer other than the conductive base body 11 and the photosensitive layer 12, such as an intermediate layer or a protective layer. A resin having a deformation at yield point of 9% or more and 29% or less is used as a binder resin contained in the photosensitive layer 12. Further, the surface of the photosensitive drum 1Y can be subjected to rubbing or the like so that the surface has a ten-point average roughness Rz (HS roughness standard B0601 ('82)) of “0.2 μm or more and 2.0 μm or less”.

The conductive base body 11 adopts a configuration where at least a surface thereof is formed of a material having conductivity. Specifically, the conductive base body 11 can adopt a configuration where the whole body is formed of a material having conductivity, such as metal, or where a surface of a nonconductive member formed for example of plastic is covered with a material having conductivity. Examples of material having conductivity are aluminum, iron, copper, tin, platinum, silver, vanadium, molybdenum, chromium, cadmium, titanium, nickel, palladium, indium, stainless steel, brass, and so on.

As described above, the charge generating agent, the charge transport agent and the binder resin are contained in the photosensitive layer 12. The charge generating agent, the charge transport agent and the binder resin contained in the photosensitive layer 12 are not specifically limited, but for example, the following materials can be used.

Examples of the charge generating agent are X type phthalocyanine (x-H2Pc), Y type oxo-titanyl phthalocyanine (YTiOPc), perylene pigment, bisazo pigment, dithioketo-pyrrolo-pyrrole pigment, non-metal naphthalocyanine pigment, metal naphthalocyanine pigment, squaraine pigment, trisazo pigment, indigo pigment, azulenium pigment, and cyanine pigment. Also, examples of the charge generating agent are powder of inorganic photoconducting material such as selenium, selenium—tellurium, selenium—arsenic, cadmium sulfide, and amorphous silicon. Also, examples of the charge generating agent are pyrylium salt, anthanthrone-based pigment, triphenylmethane-based pigment, indanthrene-based pigment, toluidine-based pigment, pyrazoline-based pigment, quinacridone-based pigment, and so on.

Generally, the charge transport agent includes a hole transport agent and an electron transport agent. Examples of the hole transport agent are benzidine derivative, oxadiazole-based compound such as 2, 5-di(4-methylaminophenyl)-1,3,4-oxadiazole, styryl-based compound such as 9-(4-diethylaminostyryl) anthracene, carbazole-based compound such as polyvinyl carbazole, organic polysilane compound, pyrazoline-based compound such as 1-phenyl-3-(p-dimethylaminophenyl) pyrazoline, hydrazine-based compound, triphenylamine-based compound, indole-based compound, oxazole-based compound, isoxazole-based compound, thiazole-based compound, thiadiazole-based compound, imidazole-based compound, pyrazole-based compound, triazole-based compound and other nitrogen-containing cyclic compound, condensed polycyclic compound, and so on.

Examples of the electron transport agent are naphthoquinone derivative, diphenoquinone derivative, anthraquinone derivative, azoquinone derivative, nitroanthraquinone derivative, dinitroanthraquinone derivative and other quinone derivatives, malononitrile derivative, thiopyran derivative, trinitrothioxanthone derivative, 3,4,5,7-tetranitro-9-fluorenone derivative, dinitroanthracene derivative, dinitroacridine derivative, tetracyanoethylene, 2,4,8-trinitrothioxanthone, dinitrobenzene, dinitroanthracene, dinitroacridine, succinic anhydride, maleic anhydride, dibromo maleic anhydride, and so on.

As described earlier, a resin having a deformation at yield point of 9% or more and 29% or less is used as the binder resin. If a binder resin having a deformation at yield point within this range is used, film scraping of the photosensitive layer 12 is suppressed. If the deformation at yield point is below 9%, the film of the photosensitive layer 12 is easily scraped, and if the deformation at yield point exceeds 29%, image defects caused by deposits and the like tend to occur.

Resin such as polycarbonate resin, polyester resin and polyarylate resin can be used as binder resin having a deformation at yield point of 9% or more and 29% or less. From the viewpoint of compatibility with the hole transport agent or the electron transport agent, polycarbonate resin should preferably be used.

For example, a polycarbonate resin including repeating units represented by the following chemical formulas (1) through (3) can be used as the polycarbonate resin. Of course, a polycarbonate resin including a repeating unit other than those illustrated below can be used.

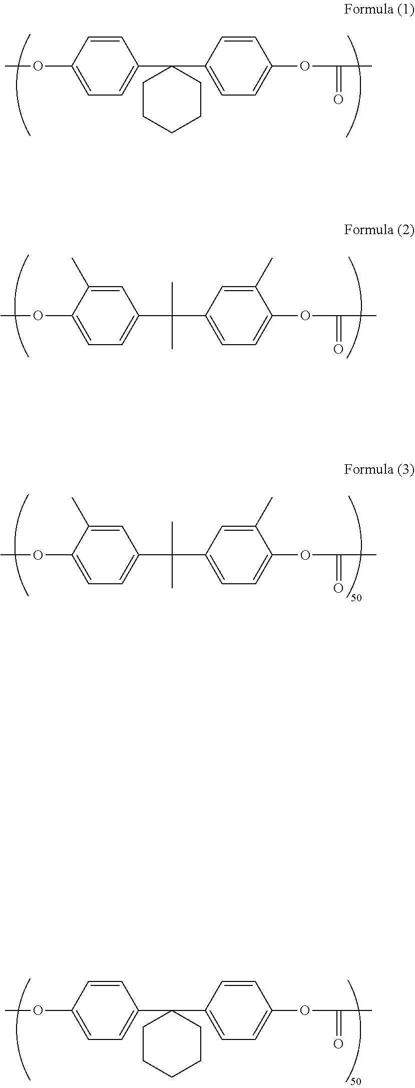

In chemical formula (3), number “50” indicates that each chemical is copolymerized by a copolymerization ratio of 50%. Specifically, it indicates that the polycarbonate resin composed of a repeating unit represented by chemical formula (3) is a resin composed of a repeating unit represented by chemical formula (1) and a repeating unit represented by chemical formula (2) which are copolymerized by a copolymerization ratio of 50%. The number of repeating units in the polycarbonate resin is not specifically limited, but the number of repeating units should preferably realize a deformation at yield point of 9% or more and 29% or less.

If polycarbonate resin is used as the binder resin, the viscosity average molecular weight thereof should preferably be 30000 or more. This is because if the viscosity average molecular weight of the polycarbonate resin is too low, it is difficult to increase the abrasion resistance of the polycarbonate resin, and the photosensitive layer 12 tends to be worn. However, if the viscosity average molecular weight of the polycarbonate resin is too high, it will not be easily dissolved in solvent, and it may become difficult to form a preferable photosensitive layer 12, since it is difficult to prepare application fluid and the like for forming the photosensitive layer 12. Therefore, the viscosity average molecular weight of the polycarbonate resin should preferably be 40000 or more and 80000 or less, and more preferably, 55000 or more and 75000 or less.

The binder resin should preferably be composed of polycarbonate resin, but it can also contain resin other than polycarbonate resin. Resin other than polycarbonate resin include thermoplastic resins such as styrene-based resin, styrene-butadiene copolymer, styrene-acrylonitrile copolymer, styrene-maleic acid copolymer, styrene-acrylic acid copolymer, acrylic copolymer, polyethylene resin, ethylene-vinyl acetate copolymer, chlorinated polyethylene resin, polyvinylchloride resin, polypropylene resin, ionomer, vinyl chloride-vinyl acetate copolymer, polyester resin, alkyd resin, polyamide resin, polyurethane resin, polyarylate resin, polysulfone resin, diallyl phthalate resin, ketone resin, polyvinyl butyral resin, polyether resin, polyester resin, and so on. Also, resin other than polycarbonate resin include crosslinked thermosetting resins such as silicone resin, epoxy resin, phenol resin, urea resin, melamine resin, and so on. Also, resin other than polycarbonate resin include photosetting resins such as epoxyacrylate resin and urethane-acrylate copolymer resin.

Further, various additives other than the charge generating agent, the charge transport agent and the binder resin can be included in the photosensitive layer 12 within a range not affecting the electrophotographic characteristics. Examples of the additives include deterioration preventing agent such as antioxidant, radical scavenger, singlet quencher, ultraviolet absorber, and so on. Also, examples of the additives include softener, plasticizer, surface modifier, extender, thickener, dispersion stabilizer, wax, acceptor, donor, surfactant, leveling agent, and so on. With the aim to improve sensibility of the photosensitive layer 12, a known sensitizer such as terphenyl, halo-naphthoquinones, acenaphthylene, and so on can be used together with the charge generating agent.

In the present embodiment, application fluid is prepared by mixing and dispersing 5 pts. mass of charge generating agent, 50 pts. mass of hole transport agent (HTM-3), 35 pts. mass of electron transport agent (ETM-2), 100 pts. mass of binder resin (viscosity average molecular weight of 67000) represented by chemical formula (1), and 800 pts. mass of tetrahydrofuran in a ball mill for 50 hours. Thereafter, the application fluid is applied onto a conductive substrate by dip-coating, and thereafter, the substrate is subjected to hot-air drying for 40 minutes at 100° C., by which the photosensitive layer 12 having a film thickness of 30 μm is formed.

### Charge Roller

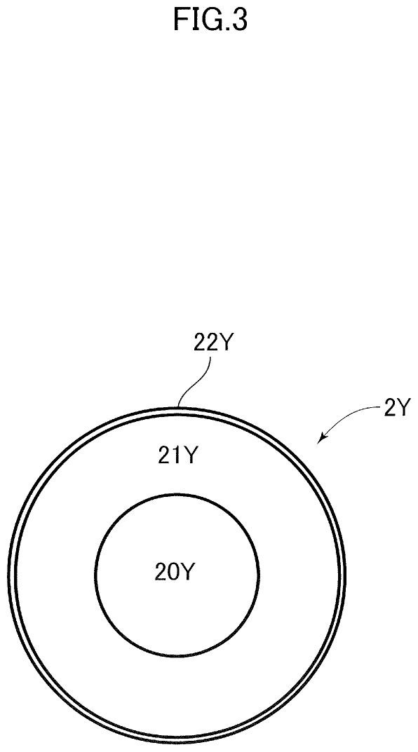

Next, the charge roller 2Y will be described with reference to FIG. 3. As illustrated in FIG. 3, the charge roller 2Y is a rubber roller including a core bar 20Y, a base layer 21Y which is a rubber layer having conductivity, and a surface layer 22Y. In the present embodiment, iron with chromium coating is used as the core bar 20Y, epichlorhydrin rubber is used as the base layer 21Y, and nylon resin-based material is used as the surface layer 22Y. The base layer 21Y is formed of a material having a volume resistivity of 10⁷ (Ω·cm) and a hardness of 62° or more and 81° or less in Asker-C hardness. The surface layer 22Y is formed by applying a coating material having nylon resin particles mixed therein as coating to the base layer 21Y, and the dimeters of the nylon resin particles are varied so that the surface roughness of the charge roller 2Y is varied. The surface of the charge roller 2Y is formed so that the ten-point average roughness (Rz: JIS Roughness Standard B0601 ('82)) is “0.9 μm or more and 8.5 μm or less” and the average interval of roughness (Sm: JIS Roughness Standard B0601 ('82)) is “50 μm or more and 200 μm or less”. In the present embodiment, as an example, the surface roughness (Rz) was set to 5 μm and the average interval (Sm) was set to 100 μm.

The surface roughness (Rz) and the average interval (Sm) are values that are measured along a rotational axis direction of the surface of the charge roller 2Y, and the measurement was performed under the following conditions using a surface roughness meter “Surfcom 480 (contact type)” (manufactured by Tokyo Seimitsu Co., Ltd.). The measurement point was one area at a longitudinal center location, with longitudinal magnification set to “×2000”, lateral magnification set to “×50”, cutoff λc set to “0.8 mm”, measurement length set to “4.0 mm”, and feed rate set to “0.3 mm/s”.

In the step of developing the toner image by the developing apparatus 4Y, image density is varied by variation of the amount of toner supplied to the electrostatic latent image according to the size of the charging potential. Therefore, in a state where unevenness has been generated in the pre-charging potential of the photosensitive drum 1Y, as described previously, unevenness of density significantly appeared in fine line images (such as a two-dot line of 600 dpi) and halftone images. That is, in the photosensitive drum 1Y having the monolayer of photosensitive layer 12, as described above, many materials such as the charge generating agent, the charge transport agent and the binder resin are coated on the photosensitive layer 12. In that case, photocarrier generated in the photosensitive layer 12 is easily trapped, i.e., carrier-trapped, while passing through the photosensitive layer 12. Generally, if the toner particle is further downsized for higher image quality, carrier trap that occurs in the photosensitive layer 12 is influenced, and charge unevenness may occur to the charging potential. Especially if there was no discharging device, i.e., pre-exposure device, for discharging the surface of the photosensitive drum 1Y prior to charge, and if a toner having a small particle size was used, charge unevenness tended to occur. This is because if absolute value of the pre-charging potential is great within a very small range of roughness on the surface of the charge roller 2Y, very small potentials created by the charge roller 2Y or very small potentials created by disturbance by toner etc. causes the charge to be deviated greatly and unevenly from the target charging potential. In consideration of this problem, in a state where evenness of pre-charging potential of the photosensitive drum 1Y cannot be ensured, especially if the device is not equipped with a discharging device, there were demands to suppress charge unevenness and ensure evenness of charging potential by the charge roller 2Y.

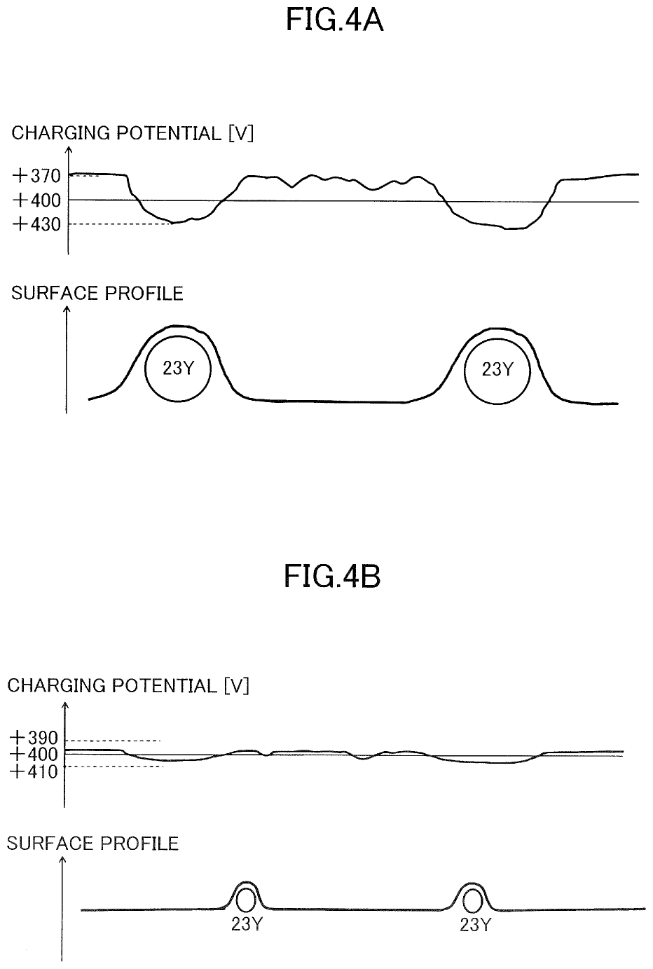

Charge unevenness of the charging potential will be described with reference to FIGS. 4A and 4B. FIGS. 4A and 4B illustrate a relationship between surface profile, i.e., roughness, of the charge roller 2Y and charging potential of the photosensitive drum 1Y charged by the charge roller 2Y within a fine range of roughness corresponding to toner size, i.e., in the order of um. FIG. 4A illustrates a state where the surface roughness (Rz) of the charge roller 2Y is 12 μm. FIG. 4B illustrates a state where the surface roughness (Rz) of the charge roller 2Y is 5 μm. The respective average intervals (Sm) is 100 μm each. In the drawing, nylon resin particles 23Y that affect the surface roughness of the charge roller 2Y are illustrated in the drawing for convenience.

As illustrated in FIG. 4A, if the surface roughness (Rz) is 12 μm, the target charging potential is “+400 V”, and since electric field tends to concentrate on the projected portion on the surface of the charge roller 2Y, the potential will be “+430 V” at the projected portion and “+370 V” at the recess portion, i.e., non-projected portion, so that charge unevenness occurs. In this state, since the potential difference is approximately “30 V”, toner is supplied for development accompanying the charging potential regardless of the mean particle diameter of toner, which is 4-6 μm, for example. In this state, as the potential difference increases, the unevenness of density becomes significant and it becomes noticeable by the user viewing the image.

In contrast, as illustrated in FIG. 4B, if the surface roughness (Rz) of the charge roller 2Y is 5 μm, compared to the case where the surface roughness (Rz) is 12 μm, the target charging potential is similarly “+400 V”. Since the projected portion on the surface of the charge roller 2Y is lower than the projected portion illustrated in FIG. 4A, the potential will be “405 V” at the projected portion and “+395 V” at the recess portion, i.e., non-projected portion, so that uniformity is realized even in a relatively minute range. In this case, since the potential difference is approximately “5 V”, regardless of the mean particle diameter of toner, even if toner is supplied for development accompanying the charging potential, unevenness of density is suppressed to such a level not noticeable by the user viewing the image.

If the surface roughness (Rz) of the charge roller 2Y is 8.5 μm or less, the above-described potential difference will be “8 V” or less, and the uniformity of charging potential by the charge roller 2Y can be ensured, thereby allowing unevenness of density to be suppressed to such a level not noticeable by the user viewing the image. The surface roughness (Rz) of the charge roller 2Y should be as low as possible. Therefore, according to the present embodiment as described above, the surface roughness (Rz) of the charge roller 2Y is set to “0.9 μm or more and 8.5 μm or less”.

The present inventors have performed an experiment in which the surface roughness (Rz) of the charge roller 2Y is varied to examine the influence on unevenness of density of the image, which in this example is the roughness of a halftone image. In the experiment, a copying machine manufactured by Canon Inc. (product name: image RUNNER ADVANCE 3330) was used. Experiments were performed respectively for a case where the surface roughness (Rz) was 5 μm according to the present embodiment and for a case where the surface roughness (Rz) was 12 μm as a comparative example, which were further divided into a case where the photosensitive drum 1Y was discharged prior to charging (with pre-exposure) and a case where the photosensitive drum 1Y was not discharged (without pre-exposure). The results of the experiment are shown in Table 1. In Table 1, images were evaluated as “poor, average, good and very good” in the named order from the image having greater unevenness of density, that is, image having greater roughness. Comparative example 2 resulted in a significant unevenness of density of image with great roughness, i.e., was poor. Comparative example 1 resulted in a somewhat better image roughness compared to comparative example 2, but the image had minute granular quality remaining, i.e., was average, compared to the present embodiment.

TABLE 1

| | | SURFACE | IMAGE |
|---|---|---|---|
| | PRE- | ROUGHNESS | ROUGHNESS |
| ENTRY | EXPOSURE | Rz (μm) | DETERMINATION |
| PRESENT | PERFORMED | 5 | VERY GOOD |
| EMBODIMENT | | | |
| PRESENT | NOT | 5 | GOOD |
| EMBODIMENT | PERFORMED | | |
| COMPARATIVE | PERFORMED | 12 | AVERAGE |
| EXAMPLE 1 | | | |
| COMPARATIVE | NOT | 12 | POOR |
| EXAMPLE 2 | PERFORMED | | |

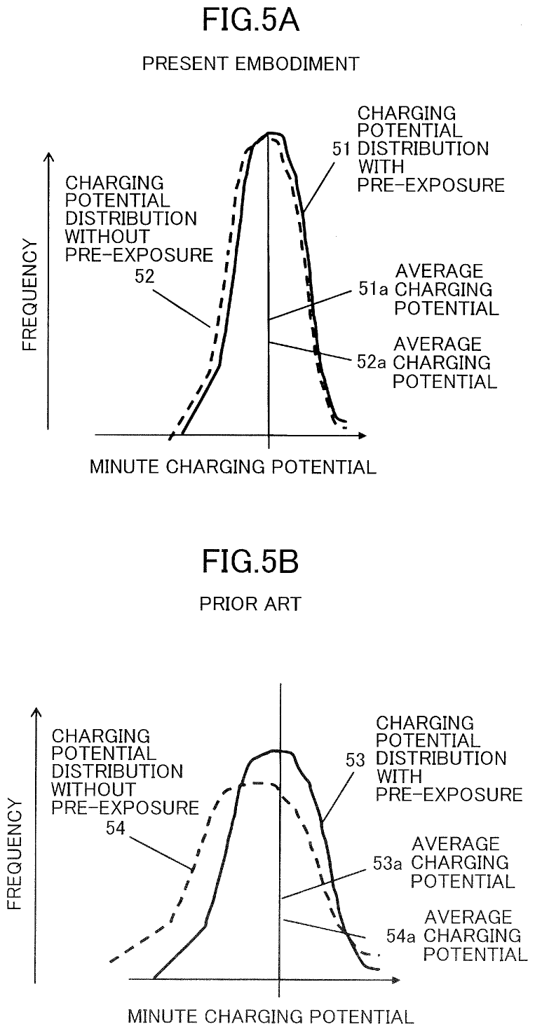

As can be recognized from Table 1, compared to the case where the surface roughness (Rz) was 12 μm, less roughness tended to occur in the halftone image in the case where the surface roughness (Rz) was 5 μm. Here, FIG. 5A is a graph illustrating a relationship between pre-exposure and charging potential of the case where the surface roughness (Rz) is 5 μm, and FIG. 5B is a graph illustrating a relationship between pre-exposure and charging potential of the case where the surface roughness (Rz) is 12 μm. These graphs schematically illustrate distribution of charging potential within a minute range. In FIG. 5A, charging potential distribution with pre-exposure is shown by a solid line curve 51, charging potential distribution without pre-exposure is shown by a dotted line curve 52, and average charging potential with pre-exposure and average charging potential without pre-exposure are shown by solid straight lines 51a and 52a. In FIG. 5B, charging potential distribution with pre-exposure is shown by a solid line curve 53, charging potential distribution without pre-exposure is shown by a dotted line curve 54, and average charging potential with pre-exposure and average charging potential without pre-exposure are shown by solid straight lines 53a and 54a. The average charging potential with pre-exposure and the average charging potential without pre-exposure were the same.

As can be recognized from FIG. 5A, in a case of the present embodiment where the surface roughness (Rz) was 5 μ, spreading of charging potential within the minute range of roughness on the surface of the charge roller 2Y is small. The charging potential within this minute range is determined by Paschen's law, and it falls within a specific range if there is very little charge unevenness. The charge unevenness is determined by average charging potential, but even in a case where there was no pre-exposure (curve 52), the charging potential only spread approximately to a same level as the case where pre-exposure was performed (curve 51). Both results were preferable.

In contrast, as can be recognized from FIG. 5B, in the case of the comparative example where the surface roughness (Rz) was 12 μm, even if pre-exposure was performed, the spreading of charging potential within the minute range of roughness on the surface of the charge roller 2Y was great (curve 53). Further, if there was no pre-exposure, greater influence is received from pre-charging potential, so that the charging potential was widened further (curve 54). In this case, electric field tends to concentrate especially on the projected portion on the surface of the charge roller 2Y, so that granular quality of the toner in the image stood out.

As described above, according to the present embodiment, the charge roller 2Y having a surface roughness (Rz) of “0.9 μm or more and 8.5 μm or less” was used to charge the photosensitive drum 1Y having the monolayer of photosensitive layer 12. Thereby, the charging potential of the photosensitive drum 1Y did not become too high at the projected portion where electric field tends to concentrate compared to the recess portion on the surface of the charge roller 2Y by applying only DC voltage to the charge roller 2Y, the differences between the charging potentials of the photosensitive drum 1Y at the projected portion and the recess portion can be minimized. That is, the photosensitive drum 1Y is not influenced by the surface profile, i.e., roughness, of the charge roller 2Y, so that uniformity of the charging potential can be maintained even within the minute range of roughness on the surface of the charge roller 2Y. Therefore, even if the photosensitive drum 1Y is not discharged before the charging step and pre-charging potential of the photosensitive drum 1Y becomes uneven, unevenness of density rarely appears on the fine line image or the halftone image.

As described, according to the image forming apparatus 100 of the present embodiment, in a case where the photosensitive drum 1Y having the monolayer of photosensitive layer 12 is charged by applying only DC voltage to the charge roller 2Y, it becomes possible to suppress unevenness of density of image caused by the surface profile of the charge roller 2Y with a simple configuration.

### Regarding Patch Ghost

Heretofore, image defects called patch ghosts tended to occur in a tandem-type full color printer. During transfer of toner image from the image forming units PM, PC and PK arranged downstream of the image forming unit PY in the direction of movement of the intermediate transfer belt 5, patch ghosts may be generated by the influence of toner image formed in the image forming unit PY (or PM or PC) arranged upstream of the image forming unit PK (or PC or PM) and transferred to the intermediate transfer belt 5. For example, in the case of the image forming unit PC, in a state where the toner images formed in the image forming units PY and PM arranged upstream of the image forming unit PC and transferred to the intermediate transfer belt 5 passes the primary transfer portion Ti in the image forming unit PC, charge remaining on the surface of the photosensitive drum 1C causes unevenness of pre-charging potential. If unevenness of the pre-charging potential of the photosensitive drum 1Y occurs, unevenness, i.e., charge unevenness, of the charging potential of the photosensitive drum 1C after charging also occurs, and even after electrostatic latent image is formed by an exposing unit 3C, the potential becomes higher compared to the circumference areas. This causes patch ghosts in which a portion having low toner image concentration becomes visible to occur during a step of developing toner image by the developing apparatus 4Y. This is caused by the same reason as the unevenness of fine line image and halftone image described earlier, which is caused by charge unevenness of the photosensitive drum 1C being generated by surface profile, i.e., roughness, of the charge roller 2C. The patch ghosts become more visible as the difference of potentials before and after charge on the photosensitive drum 1C minimizes. For example, patch ghosts tend to occur in a case where the difference between pre-charging potential and charging potential is 100 V or smaller.

Therefore, in order to suppress generation of patch ghosts, the present embodiment uses charge rollers 2M, 2C and 2K respectively having a surface roughness (Rz) of “0.9 μm or more and 8.5 μm or less” to charge photosensitive drums 1M, 1C and 1K having a monolayer of photosensitive layer 12.

The present inventors have performed an experiment regarding the image forming unit PC, where the surface roughness (Rz) of the charge roller 2C is varied and halftone images are formed to examine the influence on unevenness of density of the image, which in this example is the patch ghost. In the experiment, a copying machine manufactured by Canon Inc. (product name: image RUNNER ADVANCE 3330) was used. Pre-charging potential of the photosensitive drum 1C was measured using a surface potential meter “model 344” (product of TREK Inc.).

Experiments were performed for a case where the surface roughness (Rz) was 5 μm according to the present embodiment and for a case where the surface roughness (Rz) was 12 μm as a comparative example, while respectively varying the amounts of secondary color toner and pre-charging potentials. The results of the experiment are shown in Table 2. In Table 2, images were evaluated as “very poor, poor, average, good and very good” in the named order from the image having greater unevenness of density, that is, image having greater roughness. In Table 2, “amount of secondary color toner from upstream station” refers to a weight density of toner that differs according to whether solid patch image has been generated at the image forming unit PY or PM arranged upstream of the image forming unit PC. If solid patch image has been formed only by the image forming unit PY, the value will be “100%”, if solid patch images have been formed by both the image forming units PY and PM, the value will be “200%”, and if no solid patch image has been formed by both the image forming units PY and PM, the value will be “0%”.

TABLE 2

| | AMOUNT OF SECONDARY | | SURFACE | PATCH GHOST |
|---|---|---|---|---|
| | COLOR TONER FROM | PRE-CHARGE | ROUGHNESS | IMAGE |
| ENTRY | UPSTREAM STATION | POTENTIAL (V) | Rz (μm) | DETERMINATION |
| PRESENT | 200% | +390 | 5 | GOOD |
| EMBODIMENT | | | | |
| COMPARATIVE | 200% | +390 | 12 | VERY POOR |
| EXAMPLE 3 | | | | |
| PRESENT | 100% | +200 | 5 | GOOD |
| EMBODIMENT | | | | |
| COMPARATIVE | 100% | +200 | 12 | POOR |
| EXAMPLE 4 | | | | |
| PRESENT | 0% | +100 | 5 | VERY GOOD |
| EMBODIMENT | | | | |
| COMPARATIVE | 0% | +100 | 12 | AVERAGE |
| EXAMPLE 5 | | | | |

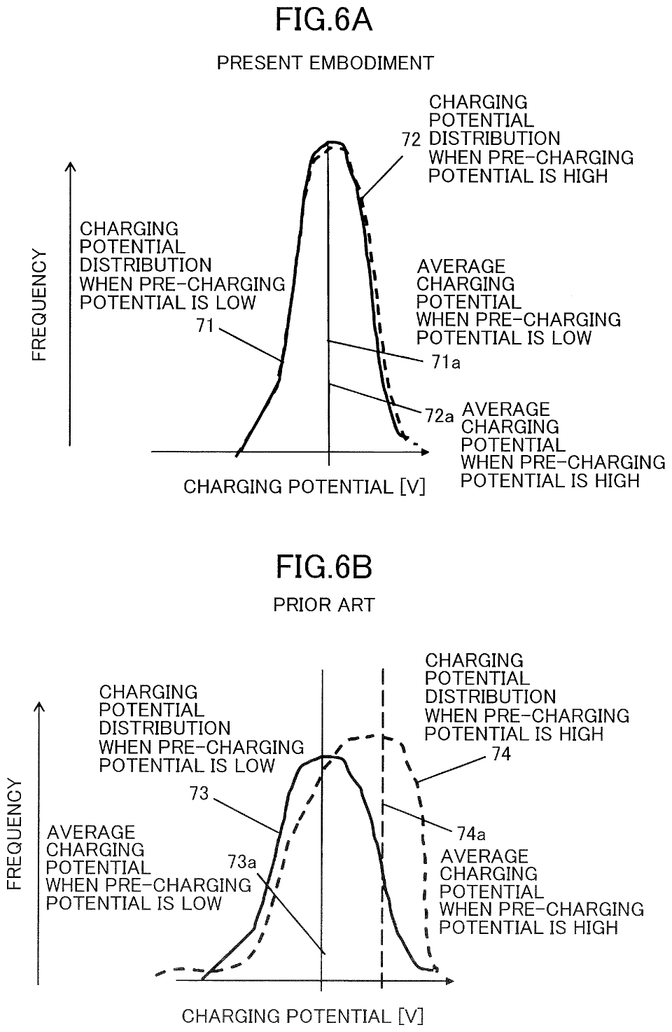

As can be recognized from Table 2, less patch ghosts tended to occur in the halftone image in a case where the surface roughness (Rz) was 5 μm compared to a case where the surface roughness (Rz) was 12 μm. FIG. 6A is a graph illustrating a relationship between pre-charging potential and charging potential in a case where the surface roughness (Rz) is 5 μm, and FIG. 6B is a graph illustrating a relationship between pre-charging potential and charging potential in a case where the surface roughness (Rz) is 12 μm. The graphs schematically illustrate distribution of charging potential in a minute range. In FIG. 6A, charging potential distribution of a case where pre-charging potential was low is shown by a solid line curve 71, charging potential distribution of a case where pre-charging potential was high is shown by a dotted line curve 72, and average charging potentials thereof are respectively shown by solid straight lines 71a and 72a. Incidentally, the average charging potentials were the same in both cases where the pre-charging potential was low and where it was high. In FIG. 6B, charging potential distribution of a case where pre-charging potential was low is shown by a solid line curve 73, charging potential distribution of a case where pre-charging potential was high is shown by a dotted line curve 74, and average charging potentials thereof are respectively shown by solid straight lines 73a and 74a. The average charging potential of the case where the pre-charging potential was high, i.e., straight line 74a, was higher than the average charging potential of the case where the pre-charging potential was low, i.e., straight line 73a.

As can be recognized from FIG. 6A, in the case of the present embodiment where the surface roughness (Rz) was 5 the spreading of charging potential within the minute range of roughness of the surface of the charge roller 2C is small. The charging potential within this minute range is determined by Paschen's law, and it falls within a specific range if there is very little charge unevenness. The charge unevenness is determined by average charging potential, but even if the pre-charging potential was high (curve 72), the charging potential spread approximately to a same level as the case where pre-charging potential was low (curve 71), and there was not much difference.

In contrast, as can be recognized from FIG. 6B, in the case of the comparative example where the surface roughness (Rz) was 12 μm, the spreading of charging potential within the minute range of roughness on the surface of the charge roller 2C was great (curves 73 and 74). Further, as shown in Table 2, if the pre-charging potential is “+390 V”, which is close to charging potential (+400 V), that is, if the pre-charging potential is high, as shown in FIG. 6B, a charging potential distribution of a high pre-charging potential becomes similar to a charging potential distribution of a low pre-charging potential being moved toward a higher charging potential side. As a result, the average charging potential becomes high so that patch ghosts tend to occur.

As described above, according to the present embodiment, in the case of a tandem type configuration in which other image forming units are arranged upstream in the direction of movement of the intermediate transfer belt 5, the photosensitive drum is charged at the downstream image forming unit using a charge roller having a surface roughness (Rz) of “0.9 μm or more and 8.5 μm or less”. Thereby, unevenness of density of image such as patch ghosts is suppressed.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2018-179898, filed Sep. 26, 2018 which is hereby incorporated by reference herein in its entirety.

What is claimed is:

1. An image forming apparatus comprising:
a photosensitive member comprising a base body, and a photosensitive layer which is a monolayer formed on the base body and comprises a charge generating agent, a charge transport agent and a binder resin; and
a charge roller configured to contact the photosensitive member and charge the photosensitive member by application of only a DC voltage,
wherein the charge roller comprises a conductive rubber layer, and a ten-point average roughness of a surface of the charge roller is 0.9 μm or more and 8.5 μm or less.

2. The image forming apparatus according to claim 1, wherein the ten-point average roughness of the surface is 5 μm.

3. The image forming apparatus according to claim 1, wherein the binder resin is a resin having a deformation at yield point of 9% or more and 29% or less.

4. The image forming apparatus according to claim 1, wherein the binder resin is a resin having a viscosity average molecular weight of 30000 or more.

5. The image forming apparatus according to claim 1, wherein the binder resin is a resin having a viscosity average molecular weight of 40000 or more and 80000 or less.

6. The image forming apparatus according to claim 1, wherein the binder resin is a resin having a viscosity average molecular weight of 55000 or more and 75000 or less.

7. The image forming apparatus according to claim 1, wherein the binder resin is a polycarbonate resin.

8. The image forming apparatus according to claim 1, wherein the binder resin is a polycarbonate resin comprising a repeating unit represented by formula (c) in which a repeating unit represented by formula (a) and a repeating unit represented by formula (b) are copolymerized by a copolymerization ratio of 50%.

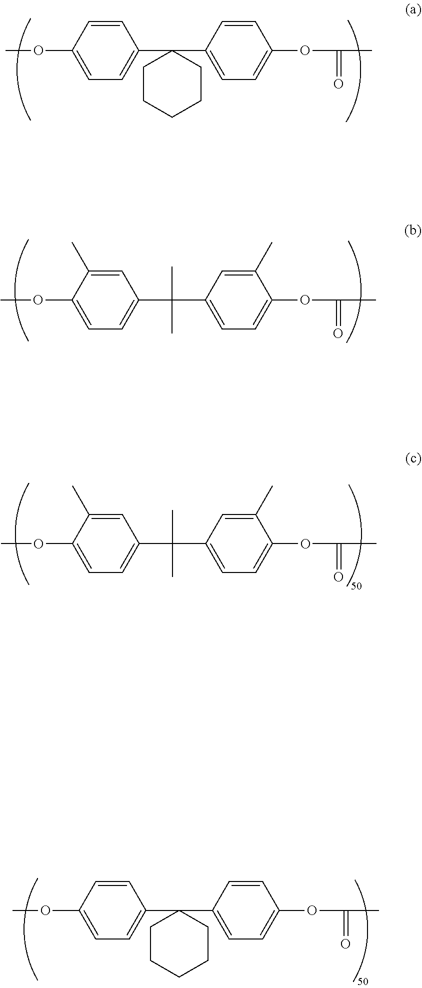

9. The image forming apparatus according to claim 1, wherein the photosensitive member has a ten-point average roughness of the surface of 0.2 μm or more and 2.0 μm or less.

10. The image forming apparatus according to claim 1, where the rubber layer of the charge roller has an Asker-C hardness of 62° or more and 81° or less.

11. The image forming apparatus according to claim 1, wherein the rubber layer of the charge roller has a volume resistivity of 10⁷ Ω·cm.

12. The image forming apparatus according to claim 1, wherein the charge roller has an average interval of surface roughness of 50 μm or more and 200 μm or less.

13. The image forming apparatus according to claim 1, wherein the charge roller has an average interval of surface roughness of 100 μm.

14. The image forming apparatus according to claim 1, further comprising
a discharge member configured to discharge the photosensitive member, the discharge member being arranged upstream of the charge roller with respect to a direction of movement of the photosensitive member.

15. The image forming apparatus according to claim 1, wherein a discharge member configured to discharge the photosensitive member is not arranged upstream of the charge roller with respect to a direction of movement of the photosensitive member, or not comprising a discharge member configured to discharge the photosensitive member.
